(19) United States
(12) Patent Application Publication
(10) Pub. No.: US 2007/0159291 A1
(43) Pub. Date: Jul. 12, 2007

(54) High-voltage thick-film high rupturing capacity substrate fuse

(75) Inventors: Marius Wilniewczyc, Warszawa-Wesola (PL); Uwe Kaltenborn, Regensburg (DE); Guido Hoffmann, Wettingen (CH); Kurt Kaltenegger, Lengnau (CH)

Correspondence Address: Paul R Katterle;Abb Inc, Legal Dept 4U6, 29801 Euclid Avenue, Wickliffe, OH, 44092-1832, US

(73) Assignee: ABB Sp.zo. o.

(21) Appl. No.: 10/557,532

(22) PCT Filed: Sep. 18, 2003
(86) PCT No.: PCT/PL03/00092

§ 371 Date: Feb. 21, 2007

(30) Foreign Application Priority Data
May 26, 2003 (PL) P360332

(51) Int. Cl. H01H 85/04

(52) U.S. Cl. 337/159

(57) ABSTRACT

The subject of the invention is a high-voltage thick-film high rupturing capacity substrate fuse. The characteristic feature of the inventive fuse is that inside a tubular insulating casing /1/, which is closed at both ends with metal endocarps /2/ and filled with arc quenching medium /3/ there is located at least one insulating substrate /4/, along which there is placed at least one fuse element /5/ in the form of a thin conducting film and which has terminal areas /6/ at its ends, which areas are electrically connected with the end-caps by specially shaped contacts /7/ located inside the end-caps. The fuse element comprises a basic part formed by multiple identical V-shaped modules and two end modules forming electric connections between the basic part and the terminal areas. In each module, the arms of the V shape, of a specific width, end with arches directed outwards /8/, which arches are connected with the arches of the arms of the neighboring modules by means of line segments, thus forming a line, which bends many times at a constant angle and has truncated vertices in each module, in which line at least one module contains at least one edge constriction /9/, enabling opening of the current path when the fuse is overloaded.

The subject of the invention is a high-voltage thick-film high rupturing capacity substrate fuse that can be used to protect high-voltage electric equipment and systems used in power engineering industry, and specially to protect transformer systems.

To protect high-voltage electric systems typical high-voltage fuses are used, which comprise a tubular insulating tube inside which an insulating ceramic support is located with spirally wound fuse element in the form of a strip. The insulating casing is tightly closed at both ends by end-caps. Free space between the external surface of the ceramic support and the internal surface of the insulating casing is completely filled with arc quenching medium. Free ends of the strip fuse-elements are connected to metal contacts, which are connected with the metal end-caps through which the fuse is incorporated in the circuit of the protected electric system. Depending on the fuse rating, fuse elements comprise a specific number of recurrent modules. The modules contain fuse element overload spots, which are made by suitable notches made in both edges of the fuse element. The shape of those notches and their appropriate arrangement significantly affect the range of the fuse functional parameters. The described high-voltage fuses require the application of a precise production process for the shaping of recurrent (within the required tolerance) constrictions in the fuse strip, and a time- and labour-consuming process necessary to wind fuse elements on insulating ceramic supports.

Besides typical high- and medium-voltage fuses, there are known other solutions, in which no insulating ceramic support or core is used. A suitably shaped fuse element in the form of a strip, tape or wire is placed in a casing, and its ends are connected with the output leads of the fuse. An example of this type of fuse is known from the publication of European patent application No. EP 0 621 621.

From the state of the art there are known electric fuses, which, instead of an insulating ceramic support and a fuse strip wound around it, comprise at least one fuse element in the form of a thin conducting film, which is applied onto a suitable supporting material, which does not conduct electric current.

Such a fuse containing a thick-film fuse element is known from U.S. Pat. No. 5,095,297. The fuse described therein contains a casing with open ends, connecting covers attached to those casing ends, a base with a fuse element being a thin, electrically conductive film, which is placed inside the casing, a disk element located in the open end of the casing inside the connecting cover, which disk element has a slot, in which the end of the base is placed, and the disk element contains solder which provides electric connection between the fuse element and the connecting cover. The fuse element has the form of a strip provided with fuse element overload spots in the form of notches cut-out in both edges of the strip. The fuse element is applied onto the ceramic base by magnetron spraying. The presented solution is suitable only for fuses of low current rating. The single and rectilinear fuse element as used in this solution does not allow for application of this solution for the protection of high-voltage and high current systems. In commonly used high-voltage fuses, the high-voltage fuse element is always longer than the standard length of fuses commonly used to protect high-voltage equipment.

Another known fuse of that type is known from U.S. Pat. No. 5,148,141. This fuse contains a casing, output leads connected to the casing, a base made of insulating material and a fuse element in the form of a thin film made of an electrically conducting material. This film is applied on the base surface and the fuse element forms a current path between the fuse output leads. On the base surface there is an additional resistive layer, which forms a resistance element outside the surface region occupied by the current path. This layer is electrically connected in parallel with the fuse element and it is a shunted current path of the fuse. This solution, like the one presented in U.S. Pat. No. 5,095,297, is not suitable for the protection of high-voltage and high current systems.

Still another example of a thick-film fuse is an electric fuse for light overload currents presented in patent description U.S. Pat. No. 4,140,988. This fuse has a cylindrical casing of insulating material, granulated arc quenching medium, which fills the casing, a base of fibreglass, which is immersed in the arc quenching medium and is covered with a conductor in the form of a conductive metal layer. The fuse also has means of connecting the fuse into an electric circuit, for example solder, and the fibreglass is saturated with water suspension of melamine resin and hydrated aluminium oxide, which has a double function consisting in ensuring good adhesion of the conducting layer to the base and in improving the conditions of arc quenching by releasing gas to blanket the arc. Although in this solution the conductor is made of a thin metal foil, from which the fuse element is etched, which makes this type of fuse suitable for use only with low electric currents, it is possible to use several fuse elements connected in parallel, in the form of a printed circuit. The fuse element is fixed in the base by means of the is layer which saturates this base. The fuse element, made by photochemical etching-out of a part of metal from the metal conductor, consist of a glow part and an overload part, which can be made, for instance, by the application of a thin silver layer onto a thin copper layer. The fuse element has the shape of identical individual meanders of constant width, arranged symmetrically to each other and connected by the overload part, whose width is larger than the width of the meanders, and the free ends of the meanders, being the end of the current path, have a shape resembling the letter “C” founded on the conductor width and they are connected with solder. The presented solution has certain drawbacks, such as:

1) complicated and expensive process of etching of the fuse element;

2) complicated structure of the base material, necessary to obtain the required adhesion between the conducting layer and the base;

3) soldered connection of the fuse element to the fuse casing, unusual in modern designs of high-voltage fuses;

4) lack of constrictions in the fuse element, which prevents arc voltage control during interruption and thus makes it impossible to use this design in high-voltage systems.

The essential quality of the high-voltage thick-film high rupturing capacity substrate fuse as per the invention, comprising a tubular insulating casing closed at both ends with metal end-caps and filled with arc quenching medium, in which at least one insulating substrate is located, along whose length there is placed at least one fuse element in the form of a thin conducting film and which has terminal areas at its ends, which areas are electrically connected with the end-caps by means of specially shaped contacts located inside the end-caps, is that the fuse element consists of a basic part, formed by many identical V-shaped modules thus forming a line bending many times at a constant angle and of two end modules providing electric connections between the basic part and the terminal areas. At least one module has at least one constriction enabling opening of the current path during fuse overload. The terminal areas are arranged along the two shorter edges of the insulating substrate.

Preferably, the angle between the arms of the letter “V” of each module of the basic part is selected to ensure appropriate insulating gaps between neighbouring modules required for high voltage.

Preferably, in each module, the arms of the letter “V” of specific width, end with arches directed outwards, which are connected with the arches of the arms of the neighbouring modules by line segments, thus forming a sine curve bending many times at a constant angle and having truncated vertices in each module.

Preferably, the constriction is located in the truncated vertex of the module.

Preferably, the constriction is formed by making mirror notches in the opposite edges.

Preferably, the constriction is located on the line segment connecting the arches of the neighbouring modules.

Preferably, the constriction is located in the module arms and it is formed by making mirror notches in the opposite edges.

Preferably, the end module has the shape of one arm of an individual module.

Preferably, the end module has the shape of a line segment.

Preferably, the terminal areas are arranged perpendicular to the longer axis of the substrate.

Preferably, on one surface of the insulating substrate there are located at least two fuse elements, which are arranged parallel to one another.

Preferably, fuse elements together with terminal areas are arranged on opposite surfaces of the substrate.

Preferably, inside the casing there are located at least two insulating substrates, which are separated from one another by arc quenching medium.

Preferably, two insulating substrates are arranged parallel to one another.

Preferably, between two insulating substrates, along the longitudinal axis of the fuse there is placed an insulating tube, in which the fuse element of the striker is placed.

Alternatively, the fuse incorporates three insulating substrates, arranged in such a way that, in cross-section, they form an arrangement similar to an isosceles triangle.

Preferably, between three insulating substrates, along the longitudinal axis of the fuse there is placed an insulating tube, in which the fuse element of the striker is placed.

Alternatively, the fuse incorporates at least two insulating substrates, arranged in a radial pattern with respect to the longitudinal axis of the fuse.

Preferably, along the longitudinal axis of the fuse incorporating at least two insulating substrates arranged in a radial pattern with respect to the longitudinal axis of the fuse, there is placed an insulating tube, in which the fuse element of the striker is placed.

Preferably, the insulating substrate is made of ceramics, glass-ceramics or glass.

Alternatively, the insulating substrate is made of a flexible material.

Preferably, the insulating substrate forms a roll, which is placed longitudinally and centrally inside the casing.

Preferably, inside the roll formed by the insulating substrate, along the longitudinal axis of the fuse, there is placed an insulating tube, in which the fuse element of the striker is placed.

Alternatively, the fuse incorporates at least two insulating substrates arranged so that the longitudinal axis of each insulating substrate lies on a circle whose radius intersects the longitudinal axis of the fuse, and the transverse axis of each insulating substrate deviates at an acute angle from the line connecting the longitudinal axis of the fuse with the longitudinal axis of the insulating substrate.

Preferably, in the longitudinal axis of the fuse incorporating at least two insulating substrates, which are arranged at an acute angle with respect to the line connecting the longitudinal axis of the fuse and the longitudinal axis of the insulating substrate there is placed an insulating tube in which the fuse element of s the striker is placed.

The advantage of the invention is the assurance of obtaining arc voltage required in high-voltage applications, by specific shaping of an individual fuse element and by the arrangement of individual fuse elements on the substrate. The shape of an individual fuse element resembling a meander of adequate length assures that the surface area of the substrate will be used to the maximum, while the outer dimensions of the substrate will be kept as small as possible. This advantage permits the placement of the high-voltage fuse element on the flat surface of the substrate in a standard-length high-voltage fuse.

The subject of the invention is illustrated by embodiment examples in the drawing, where

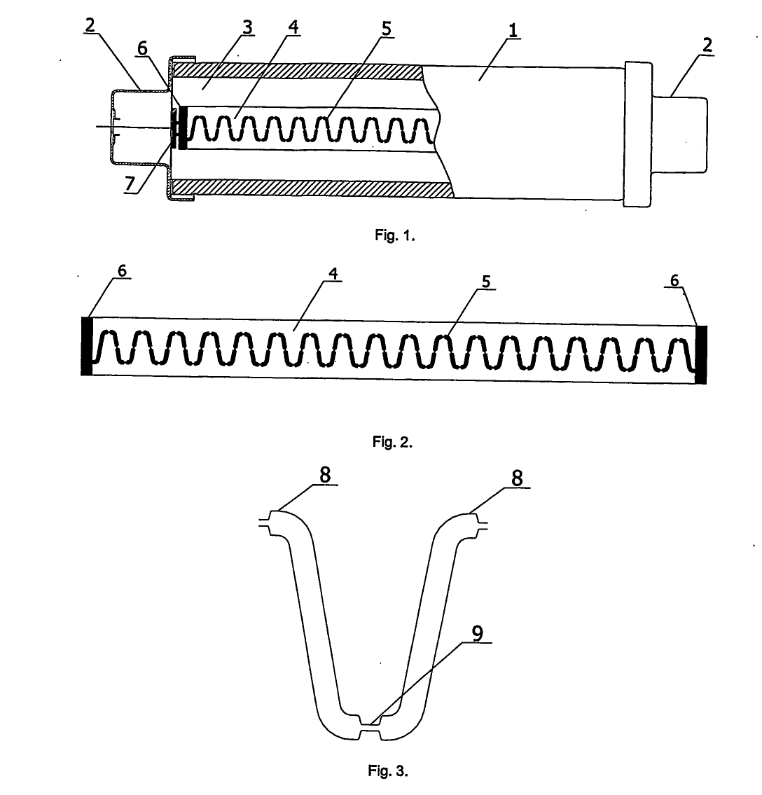

FIG. 1 shows a fuse as a partial view and partial section,

FIG. 2—a substrate with one fuse element and conducting areas (view),

FIG. 3—an individual module of the basic part with a constriction at the vertex,

FIG. 4—an individual module of the basic part with constrictions at the vertex and arms,

FIG. 5—a substrate with two fuse elements and conducting areas (view),

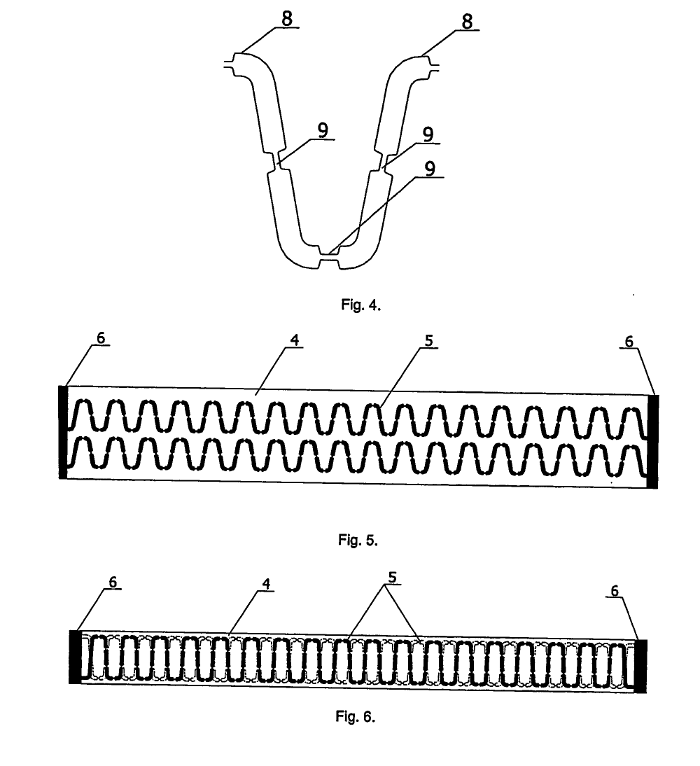

FIG. 6—a substrate with two fuse elements arranged at opposite surfaces of the substrate,

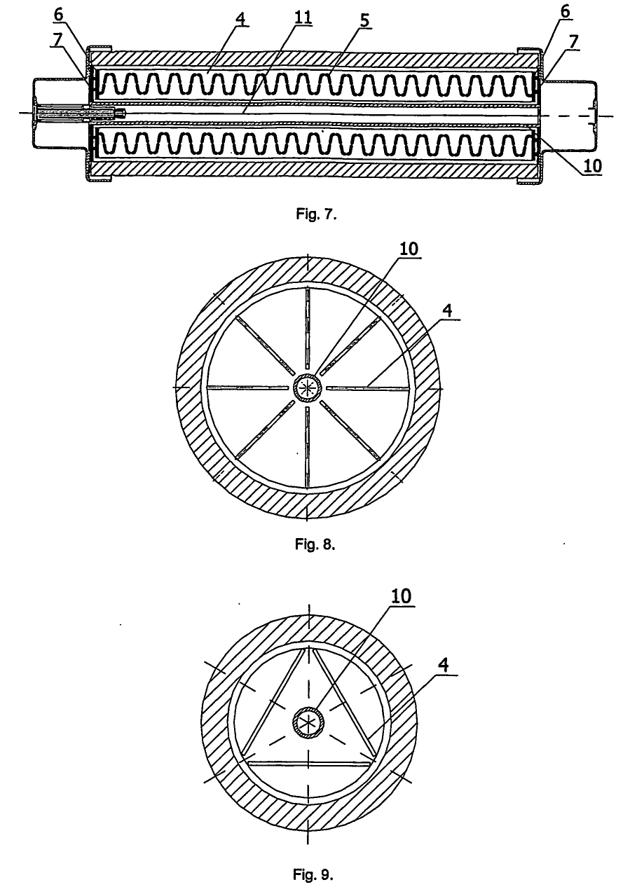

FIG. 7—a longitudinal section of the fuse with substrates and with the striker insulating tube and the striker,

FIG. 8—a cross-section of the fuse with the striker insulating tube and with substrates arranged in a radial layout,

FIG. 9—a cross-section of the fuse with the striker insulating tube and with substrates arranged in a triangle,

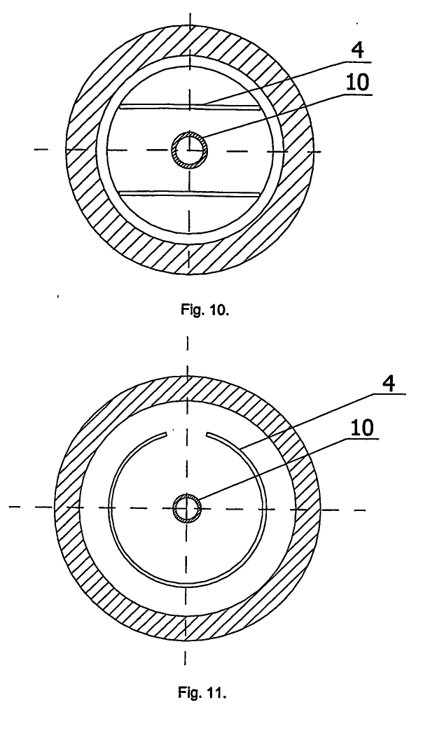

FIG. 10—a cross-section of the fuse with the striker insulating tube and with parallel arrangement of substrates,

FIG. 11—a cross-section of the fuse with the striker insulating tube and with the substrate in the form of a roll placed inside the fuse casing,

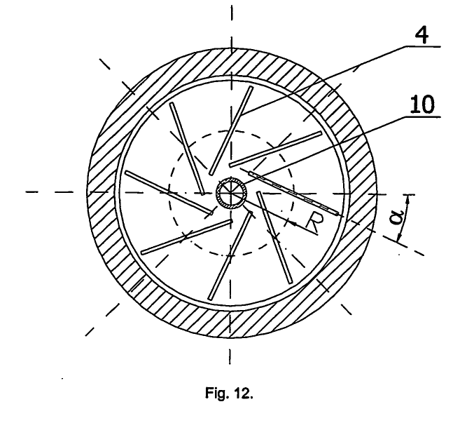

FIG. 12—a cross-section of the fuse with the striker insulating tube and with substrates arranged in such a way that the longitudinal axis of each substrate is situated on a circle with a radius of R, and the transverse axis of the substrate deviates at an a angle from the insulating tube radius intersecting the longitudinal axis of the substrate.

The high-voltage thick-film high rupturing capacity substrate fuse incorporates a tubular insulating casing 1, at both ends closed with metal end-caps 2 and filled with arc quenching medium 3, in which there are placed insulating substrates 4, with fuse elements 5 arranged on them along their length and with terminal areas 6 located at both ends of the substrate, which areas are electrically connected with the end-caps by means of specially shaped contacts 7 located in the end-caps 2. The terminal areas are located along the two shorter edges of the substrate.

The fuse element 5 comprises a basic part formed by many identical modules whose shape approximates that of the letter “V” of a specific width and two end modules, also of a specific width, forming electric connections between the basic part and the terminal areas 6. In each module of the basic part the arms of the letter “V” end with arches directed outwards 8, which arches are connected with the arches of the arms of the neighbouring modules by line segments,.thus forming a line, which bends many times at a constant angle and has truncated vertices in each module. In a special case of the embodiment of the fuse element, the arms of the letter “V” can be arranged parallel to one another thus forming a module shaped like the letter “U” (not shown in the drawing). In the embodiment shown in FIG. 3, an individual module has one edge constriction 9, which is located in the truncated vertex of the module. The constriction 9 can be made as an opening of any shape, which is not shown in the drawing. In the second embodiment example shown in FIG. 4, an individual module incorporates three constrictions 9, two constrictions being located in the module arms, and one constriction being located in the truncated vertex of the module.

In another embodiment of the invention, shown in FIG. 5, on the substrate 4 there are placed two fuse elements 5, which are arranged parallel to each other on one surface of the substrate and which are connected to the terminal 6. On one surface of the substrate there can be many fuse elements arranged parallel to one another (not shown in the drawing). The number of the fuse elements depends on the fuse electric parameters.

Then, in an embodiment shown in FIG. 6, fuse elements 5 are arranged on both surfaces of the substrate 4. As in the previous embodiment, the number of fuse elements depends on the fuse electric parameters.

In the fuse embodiment shown in FIG. 7, the fuse incorporates an insulating tube 10, placed along the longitudinal axis of the fuse, in which the fuse element of the striker 11 is located.

Depending on the number of insulating substrates used in the given fuse and on their situation with respect to the longitudinal axis of the fuse or the longitudinal axis of the insulating tube 10 of the striker fuse element 11 alternative designs of the fuse can be made.

And so, in the embodiment shown in FIG. 8, the substrates 4 are arranged in a radial pattern with respect to the fuse longitudinal axis.

In another embodiment shown in FIG. 9, the substrates 4 are arranged in such a way that, in cross section, their arrangement resembles an isosceles triangle.

In still another embodiment of the invention shown in FIG. 10, the substrates 4 are arranged parallel to each other.

In a next embodiment of the invention shown in FIG. 11, the substrate 4 is made of a flexible material and is coiled to form a roll, which is placed centrally inside the fuse, along its length.

In the embodiment shown in FIG. 12, the substrates 4 are arranged in such a way that the longitudinal symmetry axes of these substrates are arranged as in the embodiment shown in FIG. 8 in a radial pattern with respect to the fuse longitudinal axis, and substrates 4 are twisted around their own longitudinal axes at an a angle.

In the embodiments shown in FIG. 8, 9, 10, 11 and 12, between the substrates, along the fuse longitudinal axis, the insulating tube 10 is placed, in which the fuse element of the striker is placed. The same solutions can be applied in the cases where a striker is not incorporated in the fuse design.

1-25. (canceled)

26. A high-voltage thick-film high rupturing capacity substrate fuse comprising:
an insulating tubular casing closed at both ends by metal end-caps and filled with an arc quenching medium;
an insulating substrate disposed in the casing;
terminal areas located at ends of the insulating substrate, respectively, the terminal areas being electrically connected to the end-caps;
at least one fuse element disposed along the length of the insulating substrate, each fuse element comprising an electrically conductive film having a basic part and a pair of end parts connecting the basic part to the terminal areas, respectively, the basic part having an undulating shape and comprising a plurality of modules, each of the modules having a pair of arms with first ends joined together at a junction, the arms extending outwardly from the junction; and
wherein in each fuse element, the basic part has at least one constriction that permits opening of the current path during fuse overload.

27. The fuse of claim 26, wherein each module has a general V-shape, and wherein in each module, the angle between the arms is selected to provide appropriate insulating gaps between adjacent modules.

28. The fuse of claim 26, wherein in each module, the junction is a linear segment and has a constriction formed therein.

29. The fuse of claim 28, wherein in each module, the constriction is formed by mirror notches in opposite edges of the junction.

30. The fuse of claim 26, wherein each module has a constriction in one of the arms.

31. The fuse of claim 30, wherein each module has a constriction in each of the arms.

32. The fuse of claim 31, wherein each module has a constriction in the junction and in each of the arms.

33. The fuse of claim 32, wherein in each module, each arm has a second end with an arch, the arches of adjacent modules being connected together by linear segments, and wherein a constriction is formed in each linear segment.

34. The fuse of claim 26, wherein in each module, each arm has a second end with an arch, the arches of adjacent modules being connected together by linear segments, and wherein a constriction is formed in each linear segment.

35. The fuse of claim 26, wherein each end part has the shape of an arm of a module.

36. The fuse of claim 26, wherein each end part is a linear segment.

37. The fuse of claim 26, wherein the at least one fuse element comprises a pair of fuse elements disposed parallel to each other on one side of the insulating substrate.

38. The fuse of claim 26, wherein the at least one fuse element comprises a pair of fuse elements disposed on opposing sides of the insulating substrate, respectively.

39. The fuse of claim 26, further comprising a second insulating substrate disposed in the casing, the insulating substrate and the second insulating substrate being separated from each other by the arc quenching medium.

40. The fuse of claim 39, wherein the insulating substrate and the second insulating substrate are disposed parallel to each other.

41. The fuse of claim 40, further comprising an insulating tube and a fuse element of a striker disposed in the insulating tube, the insulating tube being disposed between the insulating substrate and the second insulating substrate.

42. The fuse of claim 39, further comprising a third insulating substrate disposed in the casing, the insulating substrate, the second insulating substrate and the third insulating substrate being arranged in such a way that, in cross-section, they form an isosceles triangle.

43. The fuse of claim 42, further comprising an insulating tube and a fuse element of a striker disposed in the insulating tube, the insulating tube being disposed between the insulating substrate, the second insulating substrate and the third insulating substrate.

44. The fuse of claim 39, wherein the insulating substrate and the second insulating substrate are arranged in a radial pattern with respect to a longitudinal axis of the fuse.

45. The fuse of claim 44, further comprising an insulating tube and a fuse element of a striker disposed in the insulating tube, the insulating tube being disposed along the longitudinal axis of the fuse.

46. The fuse of claim 26, wherein the insulating substrate is comprised of a material selected from the group consisting of ceramic, glass-ceramic and glass.

47. The fuse of claim 26, wherein the insulating substrate is comprised of a flexible material.

48. The fuse of claim 47, wherein the insulating substrate forms a roll that is centrally disposed in the casing and extends along a longitudinal axis of the casing.

49. The fuse of claim 48, further comprising an insulating tube and a fuse element of a striker disposed in the insulating tube, the insulating tube being disposed inside the roll formed by the insulating substrate and extending along the longitudinal axis of the casing.
